(19) United States
(12) Patent Application Publication
(10) Pub. No.: US 2004/0091650 A1
(43) Pub. Date: May 13, 2004

(54) Coating for a synthetic material substrate

(76) Inventors: Jorg Krempel-Hesse, Eckartsborn (DE); Volker Hacker, Altenstadt-Oberau (DE); Anton Zmelty, Hosbach (DE); Helmut Grimm, Darmstadt (DE)

Correspondence Address: FULBRIGHT & JAWORSKI, LLP, 666 FIFTH AVE, NEW YORK, NY, 10103-3198, US

(21) Appl. No.: 10/302,790

(22) Filed: Nov. 22, 2002

(30) Foreign Application Priority Data
Nov. 8, 2002 (DE) 102 52 543.9

(51) Int. Cl. B32B 1/02

(52) U.S. Cl. 428/35.7; 118/715

(57) ABSTRACT

A coating for a synthetic material substrate having at least one layer of a material, in which the absorption of light in the visible range is negligible, wherein the synthetic material substrate is a three-dimensional hollow body and the layer of the material has a thickness a wherein 0.5 a<a<b applies and b is the thickness of a layer of the same material at which the transmission of white light is 0.1% to 0.2%, wherein the coating provides a barrier against gases or vapors.

### FIELD OF THE INVENTION

The invention relates to a coating for a synthetic material substrate.

### BACKGROUND OF THE INVENTION

Three-dimensional hollow bodies, for example bottles for wine, beer, lemonade or water, are either transparent or pigmented. As a rule, beer bottles are, for example, brown in order to prevent damaging the beer due to the effect of light. In contrast, wine bottles are white, green or brown. The colors of these bottles are attained through the corresponding pigmenting of the glass. Even in the case of colored bottles of synthetic material, the color is attained through the pigmenting of the synthetic material. White and transparent bottles comprised of synthetic material can subsequently be provided with a color thereby that a corresponding lacquer is applied.

In the case of objects which are not three-dimensional hollow bodies, color effects are even generated by subsequently applying thin layers.

For example a method is known for the production of sun protection panes with neutral transmission colors, predetermined reflection colors as well as predetermined heat reflection properties, in which on a glass pane first a metal oxide layer, for example comprised of Sn oxide, Ti oxide or Al oxide is applied, subsequently a layer of chromium nitride and subsequently optionally again a metal oxide layer (DE 33 11 815 A1). These layers do not need to be gas-tight since the substrate on which they are applied, namely the glass, is gas-tight in any case.

Furthermore, an antithermal conducting glazing is known with modified optical properties, in which on the glass substrate a first metal oxide layer is applied (DE 15 96 825 A1). As the metal oxide is employed, for example, tin oxide, on which additionally a layer of chromium nitride can be disposed, on which a further layer of tin oxide is disposed.

In another layer system for the control of the irradiation and/or radiation of light through window panes, a metal oxide is applied on the glass substrate, on the metal oxide a metal and on the metal again a metal oxide, with the metal oxide having an index of refraction between 2.2 and 2.7 (DE 197 45 881 A1). The substrate, however, is sheet glass and not a three-dimensional hollow body of synthetic material.

A method for generating a semitransparent metal appearance of a cosmetic case is further known, which is comprised of a transparent synthetic material (WO 02/20282). This method comprises applying a metal film in a physical vacuum vapor phase, which is sufficiently thin not to be opaque. This thin film is subsequently covered with lacquer.

It is in addition known to provide a synthetic material substrate with an aluminum layer, with the aluminum layer having a thickness of 300 to 3000 Angström (30 to 300 nm). Onto the aluminum layer a synthetic layer is subsequently applied. Containers and bottles are said to obtain hereby again their metal luster after they have been treated with vapor for the purpose of sterilization (JP 59 106958 A).

Three-dimensional hollow bodies of synthetic material, for example said beverage bottles, are not sufficiently diffusion-tight against gases and vapors. A carbon dioxide-containing beverage tastes flat if this gas diffuses outwardly through the container wall in too high a degree. On the other hand, flavorings or fragrances suffer if oxygen penetrates from the outside into the container and these are destroyed or changed by oxidation.

To make three-dimensional hollow bodies comprised of synthetic material tight against volatile substances and gases, it is known to apply a layer comprised of SiO₂ or SiOₓ on the outside or the inside of the hollow body (DE 198 07 032 A1; John T. Felts: Transparent Gas Barrier Technologies, Society of Vacuum Coaters, 1990, pp. 184-193; DE 44 38 359 A1; DE 198 49 205 A1).

To improve the barrier effect it is also known to incorporate into an SiO₂ layer at least one metal from the group antimony, aluminum, chromium, cobalt, copper, indium, iron, lead, manganese, tin, tungsten, zinc and zirconium (EP 0 460 796 A2).

However, hereby no decorative effect is attained.

The invention therefore addresses the problem of providing a blocking layer for three-dimensional hollow bodies, which simultaneously produces a decorative effect with the production of the blocking layer taking place cost-effectively.

### SUMMARY OF THE INVENTION

The advantage attained with the invention comprises in particular that through the partial absorption of the visible spectrum through interference layers decorative effects are generated. A specific absorption or reflection of at least one frequency range of the visible light is achieved. The fact that the layers are relatively thin has no negative effect on the blocking effect of these layers because the blockage of metal layers against gas diffusion is not linearly related to their thickness. Thinner layers can even have a greater blocking effect than thicker layers. This is possibly caused thereby that the micropores present in the bottle material through which the gas transport takes place, are obstructed by the thin barrier layer. With increasing layer thickness of the barrier, in contrast, primarily on flexible material, such as PET, cracks occur in the barrier layer such that the gas can escape along these cracks.

An embodiment example is depicted in the drawing and will be described in further detail in the following.

### BRIEF DESCRIPTION OF THE FIGURES

FIG. 1 is a synthetic material bottle for water or lemonade,

FIG. 2 is an installation for the coating of a synthetic material bottle with a metal,

FIG. 3 is an installation for the coating of a synthetic material bottle with a metal, a metal oxide, metal nitride or metal oxinitride and/or a second metal,

FIG. 4 is the radiative reflectance of a first two-layer system as a function of different light wavelengths,

FIG. 5 shows the radiative reflectance of a first three-layer system as a function of different light wavelengths,

FIG. 6 shows the radiative reflectance of a second three-layer system as a function of different light wavelengths,

FIG. 7 shows the radiative reflectance of a third three-layer system as a function of different light wavelengths.

### DETAILED DESCRIPTION

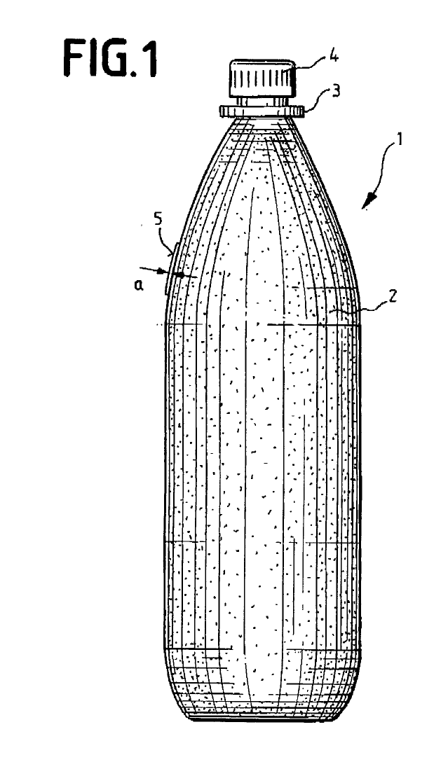

In FIG. 1 is depicted a synthetic material bottle 1 which is comprised of a receiving container 2 for a beverage, a collar 3 and a closure 4. The receiving body 2 and the collar 3 comprise for example PET and are transparent. In order to provide this transparent synthetic material bottle 1 with a color effect, a metal layer 5 is applied over the entire receiving container 2 or over portions of this receiving container 2, which metal layer is only suggested in FIG. 1. This metal layer has a thickness a between 0.5 b and b, with b being the thickness of the metal layer at which it has a transmission of approximately 0.1% to 0.2% as measured with white light.

The following Table shows at which layer thickness ranges a metal layer applied onto a synthetic material bottle has a sufficiently high reflection at a transmission which does not appear disturbing.

| | Layer thickness range | |
|---|---|---|
| Metal | [nm] | Color |
| Titanium (Ti) | 30-40 | silvery |
| Chromium (Cr) | 40-60 | bright silver |
| Tin (Sn) | 40-60 | silvery white |
| Copper (Cu) | 30-50 | reddish brown |
| Gold (Au) | 50-70 | golden |
| Special steel | 40-60 | silvery white |
| CuAl(10) | 60-80 | gold, brass colored |
| Neodymium (Nd) | ? | silvery to slightly yellowish |
| Tungsten (W) | 30-50 | lustrous white |
| Molybdenum (Mo) | 20-40 | tin white |
| Niobium (Nb) | 20-40 | light gray |
| | | (polished lustrous white) |
| Palladium (Pd) | 30-50 | bright silver |
| Aluminum (Al) | 20-40 | silvery white |
| Tantalum (Ta) | 40-60 | platinum gray |
| Rhodium (Rh) | 30-50 | silvery white |
| Platinum (Pt) | 40-60 | gray to silver |

If the tin white molybdenum is heated in air, a blue, firmly adhering and protective oxide layer forms. In air tantalum becomes covered with a protective oxide layer. The same applies to aluminum.

The colors of the metals listed in the Table are most frequently gray to silvery white, thus “metallic”. If they are applied onto synthetic material bottles, for example with the aid of a sputter process, the bottles have a more or less reflective appearance.

According to the invention the layer can have a thickness a, which is within the range of the layer thicknesses specified in the above Table, since in a three-dimensional hollow body the optic layer thicknesses are added up from the point of view of the observer.

If the bottle 1, which for example is covered all around with a 25 nm thick aluminum layer 5, is examined, the optical effect corresponds to a 50 nm thick layer on a flat glass sheet, since the 25 nm thick layer is present twice, once on the front side of the bottle and once on its backside. The light, which enters on the front side through the aluminum layer, is reflected once again on the back side. However, this applies only in such cases in which a clear liquid, for example water, is contained in the bottle 1.

The light impinging from the outside onto the metal layer of the synthetic material bottle is already largely reflected at one half of the layer thickness b and only a small portion of the intensity enters the interior of the bottle. This light subsequently impinges on the opposing side again onto a metal layer, and again a large portion of the light is reflected back into the bottle. The fraction of the intensity, which at this point still penetrates through the second metal layer to the outside is so small that this transmitted portion, compared to the light reflected on the outside, is not apparent and the bottle only appears to be reflective even though the individual layer of thickness a would appear to be partially transparent, for example if the bottle were to be illuminated from the inside.

As is known, transmission (Tr), reflection (R) and absorption (A) add up to 100%: Tr+R+A=100%. In the case of a clear bottle with clear beverage and the thin metal layer the absorption can be neglected, it is approximately A=0. Realistic values for a 25 nm thick aluminum layer are approximately 92% reflection and approximately 8% transmission on the first metal layer, i.e. of the light incident on the bottle only 8% enter the interior. Of these 8% of the original intensity again 92% are reflected and only a further 8% thereof exit through the rearward layer to the outside. This means that through the first and second layer only 0.4% of the original intensity reaches the back side. If a bottle is viewed from the front side, these 0.4% transmission through both layers are not apparent compared to the 92% reflection on the front side, since the contrast is very strong.

With a thicker metal layer thus neither a better gas barrier would be obtained nor a metal surface which subjectively would act as a better reflecting one. However, the higher reflection of the thicker metal layers would be measurable. It is, consequently, evident that through the thinner coating a sufficiently good barrier against gas diffusion and a bottle surface acting as a metal can be generated. Simultaneously material, process time and costs can be saved.

If bottle 1 contains a dark beverage or a juice, the approximate 8% fraction of the incident light intensity transmitted through the first layer is additionally attenuated in the liquid such that the second layer of the bottle back side is reached by an even weaker intensity, which is further attenuated by the second transmission through the second layer. The approximately 92% reflection on the back side metal layer, however, is thereby not affected such that the aluminum layer, in spite of the thin layer thickness, appears to the observer to be metallically reflected and not dark.

Metal layers with layer thicknesses a specified in the Table, show a contrast between the light reflected on the front side and the light fraction penetrating from behind through both layers, which is of more than sufficient magnitude. The utilization of metal layers of such low thickness is of significance for the coating of large quantities of bottles. Therewith a high coating throughput can be attained, which is of great significance for the layer deposition according to the invention by means of the sputter technique. The layers applied by sputtering, as is known, show better adhesion on the substrate than vapor-deposited layers. On the other hand, it is also known that sputtering occurs at much lower deposition rates than occur during vapor deposition such that it is not obvious to apply the sputter technique for a high throughput of at least 20,000 bottles per hour.

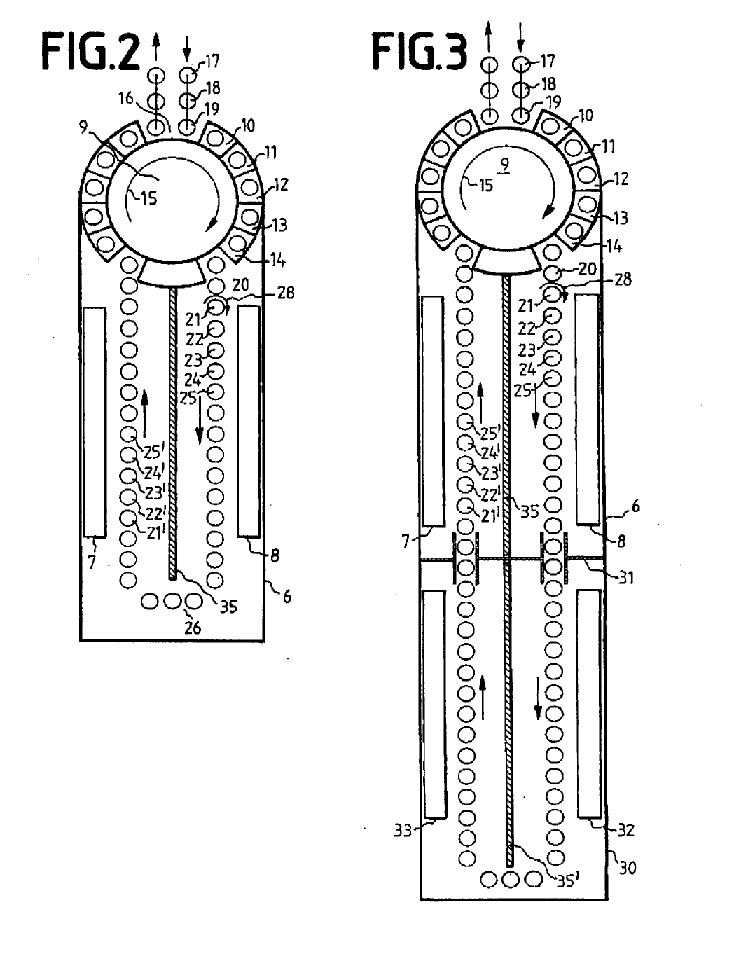

FIG. 2 shows schematically an installation for coating synthetic material bottles with metal. A vacuum coating chamber 6 contains here at least one magnetron cathode 7, 8 each on two sides. Instead of one cathode it is also possible to dispose sequentially several cathodes. Between cathodes 7, 8 a separating wall 35 can additionally be provided. At the input to the vacuum coating chamber 6 is located a chamber of a lock 9, which comprises on an annulus several receiving chambers 10 to 14. This chamber of a lock 9 rotates in the clockwise direction, as indicated by an arrow 15. Atmospheric pressure obtains at the input 16 of the chamber of a lock 9. Uncoated synthetic bottles 17, 18, 19 are placed here onto a (not shown) linear transport device which subsequently transitions over into an annular transport device. Hereby the bottles located on the transport device are moved from the atmosphere into the high-vacuum of the coating chamber 6. Here, the bottles, of which some are provided with reference numbers 21 to 25, are moved with rotation about their longitudinal axis, indicated by arrow 28, again onto a (not shown) linear transport device, with the aid of which they are guided past the magnetron cathode 8 or a series of magnetron cathodes. Metal particles are sputtered off the metal targets of these magnetron cathodes, which particles subsequently reach the outer surfaces of the synthetic material bottles. The bottles in the vacuum coating chamber 6 rotate continuously about their own longitudinal axis, and specifically at least at such a rate that a 360° rotation is completed before the bottle has passed one magnetron cathode. A uniform distribution of the coating is obtained if the rotation rate of the bottles assumes a multiple of this rate. At the end 26 of the right-side coating path the rotating bottles execute a reverse turn by 180 degrees and are now coated from the second magnetron cathode 7 with metal particles.

With the installation according to FIG. 2 the synthetic material bottles can be metallized. The metallization generates a good blocking effect against volatile substances in a beverage and simultaneously lends the bottle a high quality appearance.

However, a truly colored appearance is not yet attained with it.

A color effect, however, can be achieved by applying at least one further layer, for example a transparent oxide or nitride layer. Aluminum, chromium and additionally silicon as a nonmetal form transparent nitride layers. The nitrides of the transition metals such as Ti, Zr, Nb and Ta exhibit metallic properties such as for example electric conductivity and absorption. Thicker layers of TiN are golden, those of ZrN have the color of brass. The oxide or nitride layers only need to be transparent if they occur in layer systems which are comprised of at least one metal layer and one dielectric or ceramic layer. A coating of for example titanium nitride is golden and, as an individual layer such as gold or copper or copper aluminum, can form a decorative layer with barrier effect.

A color effect occurs if onto a first metal layer a transparent layer of a metal oxide, metal nitride or metal oxinitride is applied. Of advantage are here also layers whose oxygen and/or nitrogen content varies with increasing layer thickness, so-called gradient layers. The change of the composition in the layer structure generates defects in the crystalline structure, so-called dislocations. Through these dislocations micropores, possibly present in the layer, are closed, which increases the barrier effect of such a layer. Since the index of refraction varies with the layer composition, the layer thickness must be adapted if the same color is to be obtained which would have been obtained with a layer having a constant composition.

The following Table shows some examples of multiple coatings, with aluminum serving as the reflection layer. The thickness of the aluminum layer is herein of no significance, for which reason the layer thickness is not given. In the case of a planar coating, at a layer thickness of approximately 30 to 40 nm a sufficiently high reflection results while the transmission is approximately between 5% and 1%. While an augmentation of the aluminum layer thickness is possible, an improvement of the radiative reflectance does not result. It has been found that with a single layer on aluminum a less strongly pronounced color effect can be attained than with a three-layer system which utilizes the Fabry-Perot effect, through which many rays are brought to interference. Z and Y indicate the color coordinates in the CIE system. PET is the base substrate on which the layers are applied.

| | | | |
|---|---|---|---|
| PET | PET | PET | PET |

Layer

| | | | | |
|---|---|---|---|---|
| 1 | Al | Al | Al | Al |
| 2 | 50 nm TiO₂ | 70 nm TiO₂ | 50 nm TiO₂ | 130 nm SiO₂ |
| 3 | | 8 nm Al | 8 nm Al | 5 nm Al |
| Color | | | | |
| coordination | | | | |
| X | 0.28 | 0.27 | 0.39 | 0.24 |
| Y | 0.3 | 0.17 | 0.44 | 0.14 |
| Color | pale blue | purple | yellow | Purple |

In FIG. 3 an installation is depicted with which multiple coatings can be carried out. The upper portion of this installation corresponds largely to the installation according to FIG. 2, for which reason the same reference numbers are used. The lower portion of the installation includes a further coating chamber 30 with which a second layer can be applied onto the first metal layer. By 35 or 35′, respectively, are denoted separating walls.

Between the first coating chamber 6 and the second coating chamber 30 is located a gas separating wall 31, since for generating oxides and other compounds in the second coating chamber 30 reactive sputtering is carried out, i.e. apart from the inert gas, for example argon, which is required for the sputtering, additionally a reactive gas is introduced into the coating chamber 30. Therefore, the gases of the coating chambers 6, 30 must not be allowed to mix with one another. After the coating with a metal, for example aluminum, by means of the magnetron cathode 8, the bottles enter the coating chamber 30 and are here coated, for example, with reactively obtained TiO₂, with Ti being sputtered off a magnetron cathode 32.

The bottles transported in through the lock first receive a single metal layer, are passed through the gas separating device 31 into the second coating chamber, in which sputtering is carried out under a reactive gas atmosphere, and obtain here their transparent oxide or nitride layer. Since the coating rate in reactive sputter processes is lower than in metallic sputtering, it is advantageous to dispose the magnetron cathode as shown in FIG. 3 since hereby the slower process is carried out with two identical coating stations. It is also possible to provide a cathode with the twofold length, which, however, would lead to the already described disadvantages. After a further traversal through the gas separation wall 31 the bottles are now provided with the second metal layer at the fourth cathode.

It is entirely possible to provide between the two opposing cathodes in an installation segment the separating walls 35, 35′ if the first and the second metal are not to be comprised of the same material. If both metal layers are provided of the same metal, the utilization of the material sputtered off a target can be additionally increased thereby that the metal, flying through between two bottles, also coats the bottles on the opposing side. Thereby the coating rate of the metallic coating is also increased and the installation contamination due to coating of chamber walls is reduced.

The bottles provided in this manner with an Al and TiO₂ layer can now be provided by means of the magnetron cathode 7 with a further aluminum layer or with another metal layer. But this advantage of the disposition of the magnetron cathodes 7, 8, 32 and 33 can only be utilized if the bottles on all positions rotate about their own longitudinal axis in addition to the linear movement of the transport device.

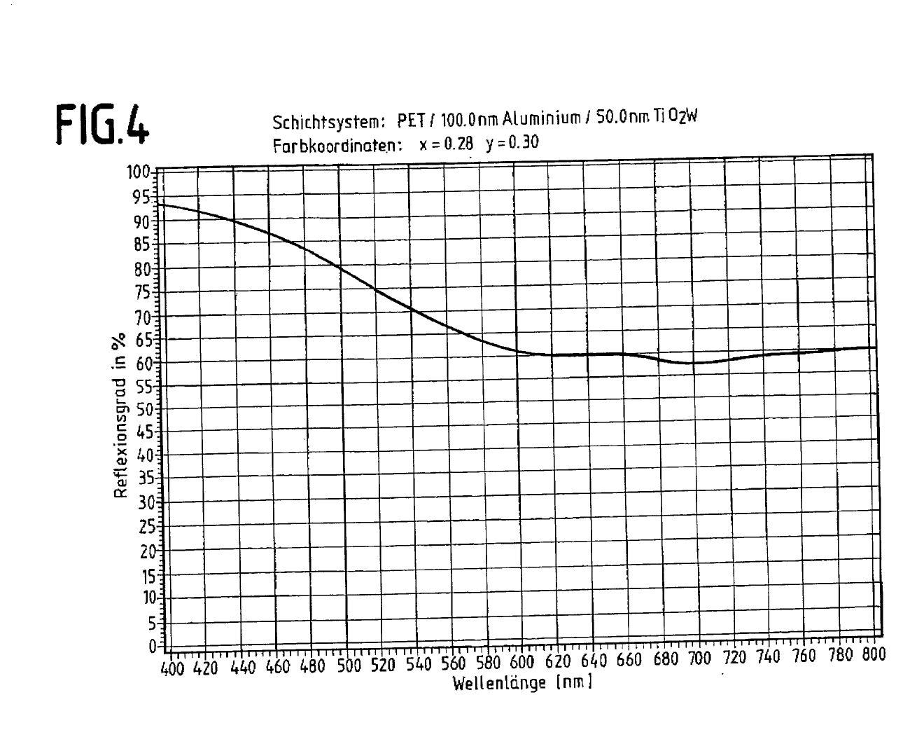

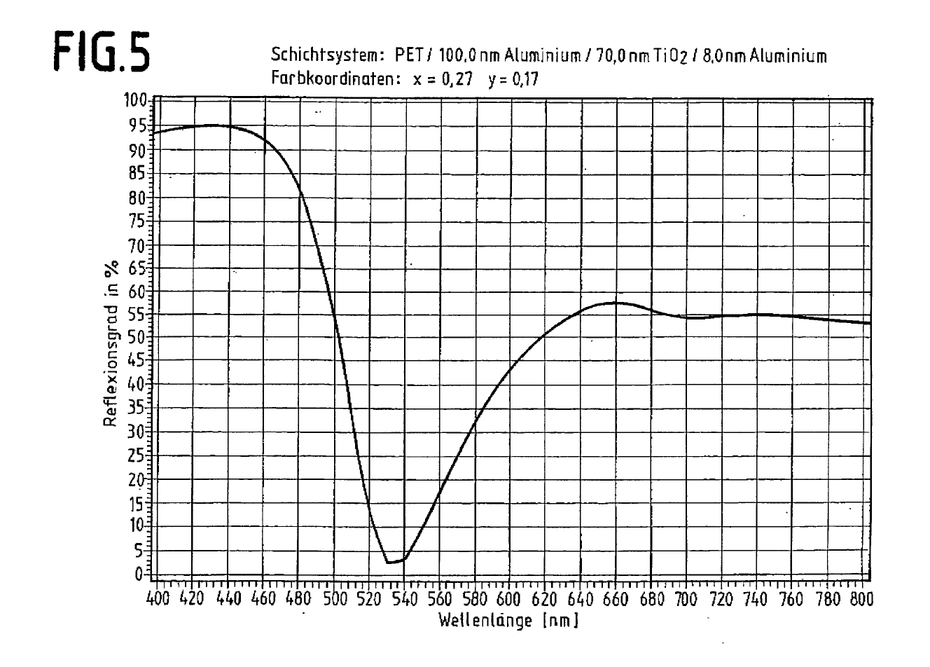

In FIG. 4 the radiative reflectance of a two-layer system over the light wavelength is depicted. This two-layer system is comprised of an aluminum layer having a thickness of 100 nm and a TiO₂ layer of 50 nm thickness, but the thickness of the aluminum layer is not critical since it serves only as a reflection layer. The color coordinates of this reflection curve are x=0.28 and y=0.3, which means the coating appears pale blue, since the reflection is stronger in the blue region than in the red region. With a 30 to 40 nm thick aluminum layer a very similar color effect is obtained at somewhat reduced reflection values which, however, are hardly perceived by the observer.

FIG. 5 shows a three-layer system comprised of aluminum of thickness b, 70 nm TiO₂ and 8 nm aluminum. It is evident that the radiative reflectance is markedly reduced in the green-yellow region while it is very high in the blue region and medium in the red region. The color resulting herefrom is purple whose color coordinates are x=0.27 and y=0.17.

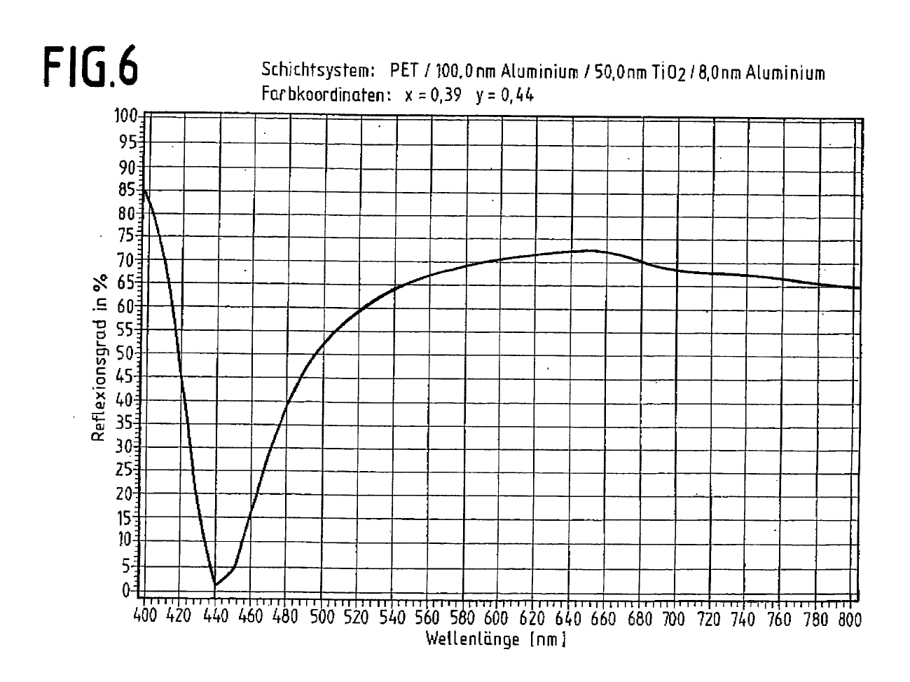

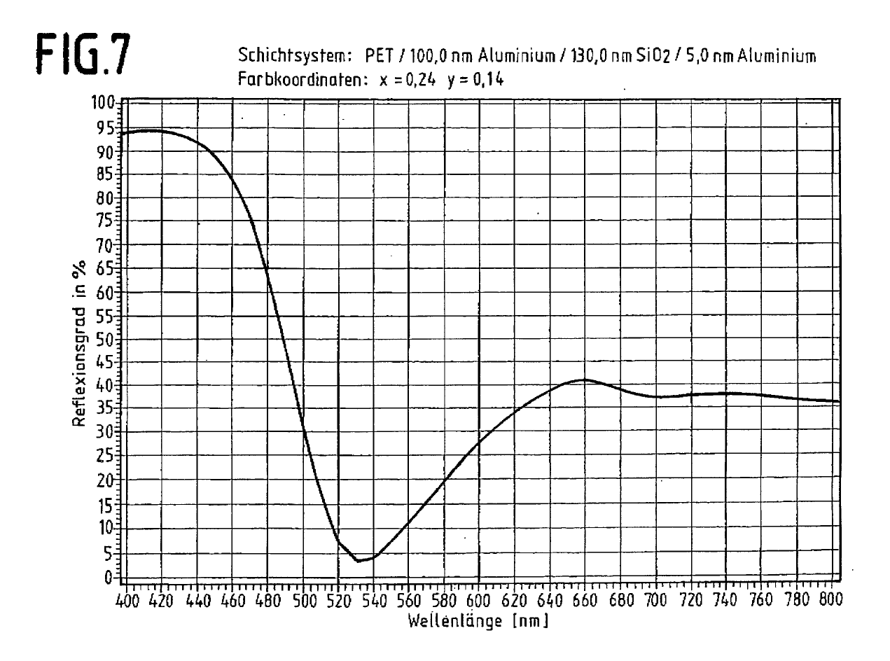

In FIG. 6 a further three-layer system is shown which is comprised of aluminum, 50 nm TiO₂ and 8 nm aluminum. The radiative reflectance hereby becomes very low in the blue region and in the yellow and red region relatively high. The resulting color has the coordinates x=0.39 and y=0.44, which means it is yellow.

FIG. 7 shows the radiative reflectance of a further three-layer system, which is comprised of aluminum, 130 nm SiO₂ and 5 nm aluminum. In the range of 530 nm the radiative reflectance is very low while in the range from 400 to 440 nm it is very high and in the range from 640 to 800 nm medium. The color coordinates are x=0.24 and y=0.14 which corresponds to the color purple. This layer system represents an alternative to the solution shown in FIG. 5, which means highly similar color effects can be achieved with other materials and corresponding layer thicknesses.

It is claimed:

1. Coating for a synthetic material substrate, with this coating having a barrier effect against gases and/or vapors and containing at least one layer of a material, in which the absorption of light in the visible range is negligible, characterized in that the synthetic material substrate is a three-dimensional hollow body and the layer of the material has a thickness a wherein 0.5 b<a<b applies and b is the thickness of a layer of the same material at which the transmission of white light is 0.1% to 0.2%.

2. Coating as claimed in claim 1, characterized in that the at least one layer is comprised of metal.

3. Coating as claimed in claim 1, characterized in that the at least one layer is comprised of a nitride of the transition metals such as Ti, Zr, Nb and Ta.

4. Coating as claimed in claim 2, characterized in that the metal belongs to the group molybdenum, niobium, palladium, aluminum, tantalum, rhodium, platinum, titanium, chromium, tin, copper, gold, neodymium, tungsten, zirconium.

5. Coating as claimed in claim 2, characterized in that onto the metal layer a transparent oxide layer is applied.

6. Coating as claimed in claim 2, characterized in that onto the metal layer a transparent nitride layer is applied.

7. Coating as claimed in claim 2, characterized in that the coating of molybdenum, aluminum or niobium has a thickness of 20 nm to 40 nm.

8. Coating as claimed in claim 2, characterized in that the coating of tantalum, chromium, tin or platinum has a thickness of 40 nm to 60 nm.

9. Coating as claimed in claim 2, characterized in that the coating of palladium, copper, tungsten or rhodium has a thickness of 30 nm to 50 nm.

10. Coating as claimed in claim 2, characterized in that the coating of titanium has a thickness of 30 nm to 40 nm.

11. Coating as claimed in claim 2, characterized in that the coating of gold has a thickness of 50 to 70 nm.

12. Coating as claimed in claim 2, characterized in that the metal is a metal alloy.

13. Coating as claimed in claim 12, characterized in that the metal alloy is comprised of copper and aluminum and has a thickness of 60 nm to 80 nm.

14. Coating as claimed in claim 12, characterized in that the metal alloy is comprised of special steel and has a thickness of 40 nm to 60 nm.

15. Coating as claimed in claim 5, characterized in that the oxide layer is comprised of SiO₂.

16. Coating as claimed in claim 2, characterized in that the metal layer is comprised of aluminum on which is disposed a TiO₂ layer.

17. Coating as claimed in claim 16, characterized in that on the TiO₂ layer is disposed a further aluminum layer.

18. Coating as claimed in claim 2, characterized in that the metal layer is comprised of aluminum on which is disposed an SiO₂ layer.

19. Coating as claimed in claim 18, characterized in that on the SiO₂ layer is disposed a further aluminum layer.

20. Coating as claimed in claim 16, characterized in that the TiO₂ layer has a thickness of 50 nm.

21. Coating as claimed in claim 17, characterized in that the TiO₂ layer has a thickness of 70 nm and that on this TiO₂ layer an aluminum layer of a thickness of 8 nm is disposed.

22. Coating as claimed in claim 20, characterized in that on the TiO₂ layer is disposed an aluminum layer having a thickness of 8 nm.

23. Coating as claimed in claim 19, characterized in that on the SiO₂ layer is disposed an aluminum layer having a thickness of 5 nm.

24. Coating as claimed in claim 1, characterized in that the at least one layer is comprised of an oxinitride.

25. Device for the production of a coating for a synthetic material substrate, characterized by
a) a first magnetron cathode configuration (8) in a coating chamber (6) and
b) a second magnetron cathode configuration (7) in the coating chamber (6), which is disposed parallel and at a distance from the first magnetron cathode configuration (8),
c) a first transport path for the synthetic material substrate (21 to 25), which leads past the second magnetron cathode configuration (8),
d) a second transport path for the synthetic material substrate (21 to 25), which leads past the second magnetron cathode configuration (7),
e) a connection (26) between the first and the second transport device.

26. Device as claimed in claim 25, characterized in that the first and the second transport path end in a chamber of a lock (9), whose one side is exposed to the atmosphere and whose other side to the high-vacuum of a coating chamber (6).

27. Device as claimed in claim 25, characterized in that a second coating chamber (30) adjoins the first coating chamber (6), and the coating chambers (6, 30) are separated by means of a gas separation wall (31).

28. Device as claimed in claim 27, characterized in that the second coating chamber (30) comprises two opposing magnetron cathode configurations (32, 33).
